(19) United States
(12) Patent Application Publication
(10) Pub. No.: US 2023/0398721 A1
(43) Pub. Date: Dec. 14, 2023

(54) CASTINGS WITH PLASTIC OVERMOLDING

(71) Applicant: ZOE ANGLING GROUP, LLC, Chattanooga, TN (US)

(72) Inventor: Jeffrey D. COFFEY, Sherwood, OR (US)

(21) Appl. No.: 17/836,894

(22) Filed: Jun. 9, 2022

(51) Int. Cl. B29C 45/14; B29C 45/00

(52) U.S. Cl. CPC B29C 45/14819; B29C 45/1418; B29C 45/0001; B29K 2023/065

(57) ABSTRACT

Metal castings are encased with an injection-molded plastic coating. In embodiments, a raw casting is formed from a metal such as bismuth. The raw casting is subsequently encased in a plastic cover using an injection molding process to create a coating to a precise thickness, necessary to prevent splitting. The coating provides durability and longevity to the casting, which may be fabricated from a relatively brittle metal. Other embodiments may be described and/or claimed.

### TECHNICAL FIELD

Disclosed embodiments are directed to techniques for enhancing the durability of cast metal, and in particular to plastic over molding of castings made from bismuth, lead, or another suitable metal.

### BACKGROUND

Many different types of equipment used in outdoor recreation such as hunting, fishing, and boating require weighting for proper use and function. More specifically, dense weighting is desirable to achieve a good weight to size balance. For example, the effectiveness of shotgun shells, which have a limited volume for carrying shot, typically increases when a relatively dense material is used for shot to maximize the amount of energy delivered to a target downrange. Fishing tackle can carry farther on casts when a relatively small but comparatively heavy weight is used, minimizing wind resistance while maximizing the energy carried from the casting motion. Boat anchors can be made smaller to consume less space on board, while still providing sufficient weight for good holding power.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates the operations of an example method for creating a metal casting that is encased in an injection-molded plastic shell, according to various embodiments.

FIG. 2 illustrates an example mold for creating a casting to be encased in an injection-molded plastic shell, according to various embodiments.

FIG. 3 illustrates an example plastic injection mold for coating a casting, such as a casting created using the example mold of FIG. 2, in injection molded plastic, according to various embodiments.

FIG. 4 illustrates an example plastic-coated casting that may result from the method of FIG. 1 used in conjunction with the molds of FIGS. 2 and 3, according to various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Lead is the primary element historically used to create weight in hunting, fishing and boating equipment, including shot, bullets, lures, jigs, spinners, bobbins, anchors, etc. Lead has been used due to its relative abundance, ease of casting and processing due to its low melting point and softness, and relatively high density compared to most other materials. In the course of recreational activities such as hunting and fishing, lead is inevitably left in the environment. Shot from shotgun shells and bullets is widely dispersed during hunting. Likewise, sinkers, lures, and other types of fishing tackle may be left in rivers, lakes, and oceans due to broken fishing lines. In both cases, recovery of the lead is nearly impossible. This is undesirable because, as has been long known, lead is toxic to the environment.

Awareness of the threat of environmental damage from lead that gets left behind in the wake of recreational activities has been growing. This awareness has been driving the sporting goods industry to switch to alternative materials that are more environmentally friendly, while still offering somewhat comparable weight and density as lead. For some equipment, brass may be used instead of lead, but is more expensive than lead alone. Furthermore, some types of brass also contain lead, which may leach toxins into the environment. Steel has been used for a number of years as an environmentally friendly alternative to lead shot. However, steel is less dense than lead and so does not carry as far or provide as much downrange stopping power as lead, resulting in an increased risk of only injuring game instead of killing. Moreover, steel, being harder than lead, can also cause gun barrels to wear faster. Steel also melts at a significantly higher temperature than lead, making its processing into various forms for fishing jigs more difficult.

Some manufacturers have begun using bismuth as a replacement for lead. Bismuth is a cost effective, non-toxic alternative, which offers a density that approaches lead (˜85-90%) and a lower melting temperature that allows it to be formed using substantially the same equipment as lead. However, bismuth is more fragile and shatters easily. While anglers often desire tackle in an array of colors depending on the type of fishing and species intended for catch, paint typically will not adhere to bismuth. Nickel plating is an alternative, but it also cannot be colored. At present, weights may be colored by dipping in a powder coating for color, which may then be baked on, and can provide a measure of durability. However, the resulting powder coat is often prone to cracking and chipping. If the powder coating chips, the underlying bismuth is again likely to crack or shatter, rendering the weight useless.

Furthermore, when metal hits rock it can make a sound that will startle fish if sufficiently loud. Owing to its relative softness, lead tackle typically makes a light thud when it hits. Bismuth, however, is more brittle and less malleable, and so will often make a louder sound when striking rock, and may also fragment or shatter due to its brittleness.

Disclosed embodiments address these shortcomings by using an injection molded process to encapsulate a molded weight or other object. The injection molding process allows the use of different plastic formulations from those offered as powder coatings, and that can create a suitably tough yet flexible plastic. The injection molded coating can be provided in a range of colors similar to a powder coat, and can also act to minimize impact sounds due to its relative flexibility. The plastic coating creates a softer, more natural sound when it is dragged across the rocks, similar to that of lead. At the same time, the injection molded coating is sufficiently flexible to resist chipping and absorb impact forces to minimize fracturing or breakage of the underlying metal, whether bismuth or another suitable metal.

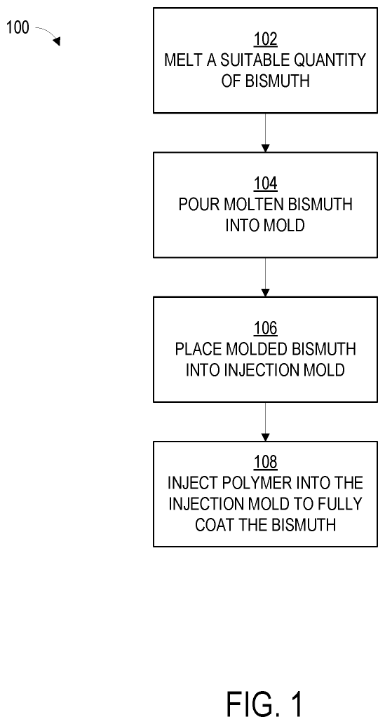

FIG. 1 illustrates the operations of an example method 100 for creating a plastic-coated bismuth casting, such as a jig head or other fishing implement. Depending on the specifics of a given embodiment, some of the operations may be omitted or other operations may be added. Furthermore, while the operations are described with respect to an embodiment for creating a fishing implement, it should be understood that the operations may be used to create any suitable plastic coated bismuth casting, regardless of intended use or purpose. Furthermore, in some implementations, the operations may be used with a metal other than bismuth.

In operation 102 of the example embodiment, an appropriate quantity of bismuth metal is melted. The appropriate quantity may be determined by the intended casting to be manufactured, as well as the quantity of castings and configuration of the initial molds, described below. The bismuth metal may be heated past its melting point of 271° C./519.8° F. to a temperature appropriate for the casting process, to ensure the liquid metal can flow correctly into the mold and to help ensure the resulting castings are fully and properly formed. Furthermore, the temperature may be selected such that the cast metal will have any desired qualities that are temperature-dependent, e.g. hardness, crystal structure, etc. It will be understood by a person skilled in the relevant art that the correct temperatures or range of temperatures will accordingly vary depending on the specifics of a given implementation, and will vary if this method is employed with metals other than bismuth.

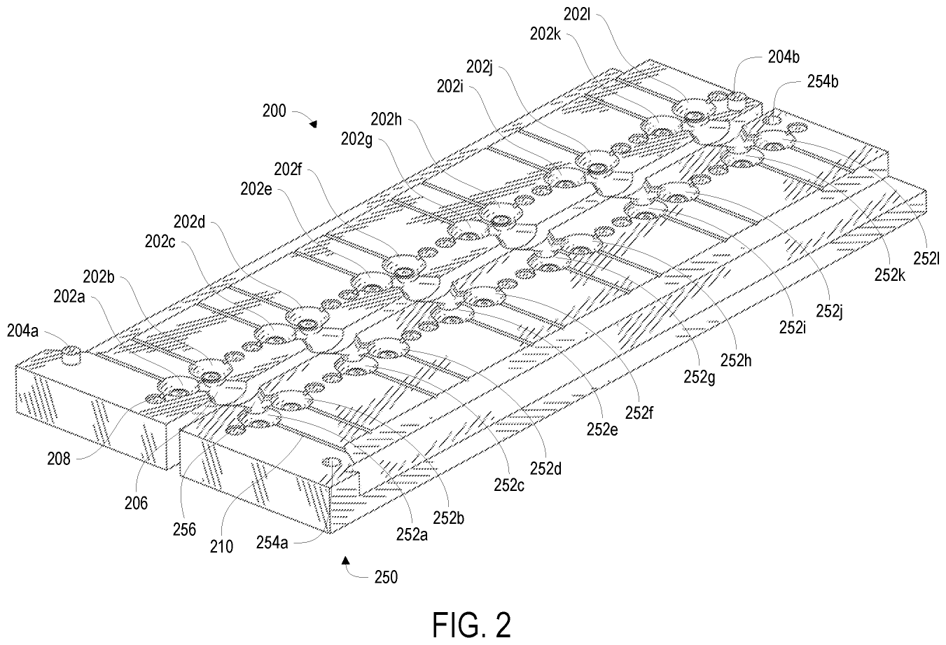

In operation 104 of the example embodiment, the molten bismuth is next poured into an initial mold to create raw castings. One or multiple raw castings may be created depending upon the mold configuration. The mold configuration will also depend upon the particular objects being fabricated. In the case of fishing tackle, the mold may be for a jig head, sinker, or another desired lure or fishing implement. For example, FIG. 2, discussed infra, depicts a mold for a jig head. As will be understood by a person skilled in the relevant art, the raw castings may also include material that may be subsequently removed, such as stems, runners, sprue, shanks, and/or other structures incident to the casting process. This excess material may help to ensure that the portion of the mold that creates the raw casting is correctly and completely filled, and also can help accommodate material contraction as it cools as well as aid in removal of the castings and subsequent processing.

The molten bismuth, in embodiments, may be hand poured. In other embodiments, it may be poured using a machine. In some embodiments, a pouring machine may be computer controlled, and may include sensors connected to the controlling computer to help determine when the pour has been correctly completed and the mold is fully filled. The casting may be removed from the mold once sufficiently cooled. Sufficient cooling may be determined on a time basis, with the mold being held shut for a predetermined amount of time, or may be determined via sensor. The amount of cooling time may depend on the type of metal being cast, as well as the size and shape of the castings. As will be understood, the raw castings may not need to be cool to the touch before removal, and may be removed and allowed to cool separately to free up the mold for subsequent rounds of casting.

In operation 106 of the example embodiment, the raw castings are next placed into a plastic injection mold. Operation 106 may be commenced when the raw castings have cooled to an appropriate temperature. Depending upon the metal used for the raw castings, when the castings are released from the initial mold, and the type of plastic used for the subsequent injection molding operation, the castings may need to be further cooled before injection molding. In other embodiments, the castings raw castings may need to be raised or held at a particular temperature or range of temperatures to correctly cooperate with the subsequent injection molding operation.

The plastic injection mold may, in some embodiments, be configured to accommodate the same number of raw castings that result from operation 104, so that a single batch of raw castings can be accommodated in a single plastic injection mold. In other embodiments, the number of raw castings accepted by the plastic injection mold may differ, depending upon the needs of a specific implementation. The plastic injection mold may be created with runner, sprue, and gate openings of a specific predetermined size and/or angle to ensure that the subsequently injected plastic will surround and encapsulate the raw casting, without cooling prematurely and at the right speed.

Finally, in operation 108 of the example embodiment, the raw castings are encased in plastic within the plastic injection mold via an injection molding process. The plastic may be colored to a desired or suitable color, depending upon the requirements for a given implementation and casting. In one embodiment, the plastic is a polymer resin such as high-density polyethylene (HDPE). The plastic injection mold is configured so that the raw casting is centered within the mold during the injection process for complete encapsulation. As discussed above, the mold's various features such as runners, sprue, and gate openings are configured so that air can leave the mold as the liquid plastic resin is injected, but the resin will not seep out, and the amount of trimming needed post-injection molding is minimized. In the example injection process using HDPE, the resin is heated to around or at 120 degrees F., or around 48-49 degrees C. The mold, in the example embodiment, is configured so that the injection molding process results in a resin thickness around the raw casting at or around 0.92 mm. This thickness will prevent the plastic molding from splitting as it shrinks during cooling, and otherwise exposing the raw casting metal. Conversely, walls substantially thicker than 0.92 mm may overly bulk up the final size of the encased casting and/or unnecessarily waste resin by not offering any advantages over a thinner wall thickness.

It is the size of the casting and resin utilized for molding that are the primary factors determining thickness. Thus, the thickness of 0.92 mm is with the use of HDPE resin, molded over a raw casting made from bismuth. This thickness is determined to be appropriate for a non-hollow bismuth casting of approximately ¼ ounce (approximately 7 grams). For a ½ ounce (approximately 14 grams) non-hollow bismuth casting, a thickness of just over 1 mm of HDPE resin is determined to be appropriate. Generally speaking, the appropriate thickness of HDPE will increase or decrease in correlation with an increase or decrease in the size of the object. Thus, it will also be understood that the weight of the object for a given thickness will vary depending upon the material used for the casting. For example, a casting made from lead that is comparable in size to a ½ ounce bismuth casting will be heavier due to lead's greater density, and similarly, a casting made from aluminum that is comparable in size will be lighter. In each case the HDPE thickness will be substantially similar, as the size is comparable.

Other types of metals and/or resins may necessitate a thinner or thicker wall, depending upon the characteristics of the materials used. For example, polystyrene may require a thinner wall, due to its surface characteristics, which are similar to silicone. Different resins may have different shrink rates, which may require adjustment to the thickness of the wall. A resin with a relatively low shrink rate may be utilized with a thinner wall thickness, while a resin with a relatively high shrink rate may need a thicker wall. Similarly, resins with different elasticities may require different thicknesses to avoid splitting. For example, a relatively elastic resin, compared to HDPE, may be able to use a thinner wall thickness compared to a resin that is more rigid and inelastic compared to HDPE, where a thicker wall is necessary to prevent splitting. Furthermore, while the foregoing contemplates a relatively uniform wall thickness, different casting shapes may utilize a wall thickness that varies in some parts of the casting. For example, some shapes may be prone to expose a particular part of the casting to a greater degree of wear and impact than other portions. These portions that are exposed to greater wear and/or impact may benefit from a thicker resin wall to enhance durability and/or sonic characteristics.

Still further, in some embodiments the resin may be provided in an array of colors, to better match different possible types of fish and/or bodies of water. For example, ocean fishing, which may be more murky and will have different species of fish than a freshwater lake, may necessitate a different lure configuration with different colors from a lake that is relatively calm with clear water. Some molds may be configured to impart a glossy finish to the exterior of the plastic coating which may be desirable in certain lighting conditions and/or to provide a slicker surface against impacts, while some molds may impart a matte finish for different fishing conditions. Additionally, some molds may be configured to emulate features of bait, such as gills, eyes, fins, tails, worms, etc. These features may be emulated in the plastic coating and so created by the injection mold, and/or as part of the underlying casting.

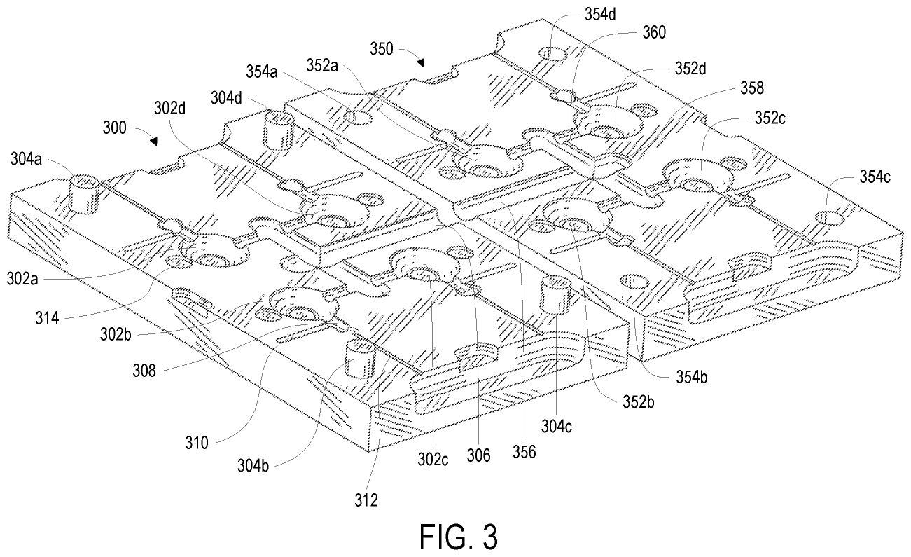

Turning to FIG. 2, a first example mold, illustrated as two halves 200 and 250, is used to create the raw castings, such as raw bismuth castings, which may subsequently be encapsulated in plastic using an injection mold such as the mold depicted in FIG. 3 and described below. As can be seen in the depicted embodiment, each of the two halves 200 and 250 are substantially mirror images of each other. This is a result of the relatively symmetrical nature of the casting design. It should be understood that castings that do not have a symmetrical nature may have mold halves that do not mirror each other. The materials and design of the mold may be selected with respect to the material being cast, such as bismuth, lead, copper, aluminum, an alloy, etc., as will be understood by a person skilled in the relevant art. Molds intended for casting metals with relatively high melting points, such as aluminum or copper, may need to be fabricated from materials that can withstand such high temperatures without damage or appreciable change in dimension, to ensure casting accuracy. For example, some such molds may be fabricated from graphite. For other metals, the molds may need to be coated or treated in their interior, to ensure the cast metal will reliably release. For casting bismuth, such as in the depicted embodiments, the mold may be fabricated from aluminum or another suitable material, as bismuth has a relatively low melting temperature.

In the mold halves 200 and 250, a plurality of cavities 202a through 2021, for half 200, and corresponding cavities 252a through 2521, are provided. Each cavity 202 in half 200 has a corresponding cavity 252 in half 250 arranged so that when half 200 is matched to half 250, a complete mold cavity is formed in the shape of the desired casting. Each cavity 202 and 252 is configured to create any desired features for the finished casting. While cavities 202 and 252 are depicted as symmetrical in the depicted embodiment, in other embodiments cavity 202 may differ in features from cavity 252, where asymmetric castings are desired. The cavities 202 and 252 should closely match when the halves 200 and 250 are joined to create an accurate casting. To help ensure accuracy, half 200 may be equipped with one or more registration pins 204a and 204b, which fit into corresponding registration sockets 254a and 254b. These pins and sockets are positioned on their respective halves to ensure that the halves 200 and 250 are precisely joined, so that all cavity feature halves correctly match together.

Each of the cavities may be fed by a sprue, formed by sprue half 206 mating with sprue half 256. In the depicted embodiment, the mold is configured so that each sprue feeds into two cavities, such as formed by cavities 202a, 252a, 202b, and 252b (not all sprues are labeled in FIG. 2). When the mold halves 200 and 250 are joined, the sprues form a funnel shape into which molten metal, such as molten bismuth, may be poured. The sprue conducts the molten metal into the mold cavity formed by the joined mold halves 200 and 250.

In various embodiments, each of the mold halves 200 and 250 may have additional features apart from the cavities 202 and 252, as can be seen in FIG. 2. For example, each cavity 202 and 252 may include additional features such as tabs 208 and stems 210. In some embodiments, tabs 208 and stems 210 are cavities to accommodate inserts, such as wires, around which the molten metal is cast. For example, tabs 208 may accept a wire loop to form an eyelet, and stems 210 may accept a wire “tail”, components which may pass through the cavities 202 and 252, to become integrated into the final casting. In other embodiments, these tabs 208 and stems 210 may be left empty, to be formed from the molten metal as part of the casting process. In some such embodiments, the tabs 208, stems 210, and/or any other features may be subsequently machined from the raw casting. In still other embodiments, one or more of the additional features may be inserted or created to facilitate handling of the raw castings in subsequent processing operations, such as maintaining the casting within the injection mold in a proper position to create an even coating of plastic. Such features may be removed as part of finishing the casting if they are no longer needed, or may become part of the final product, depending upon the intended final design of the finished casting.

FIG. 3 illustrates a second example mold, illustrated as two halves 300 and 350, used to encapsulate raw castings, such as raw bismuth castings created using the first example mold illustrated in FIG. 2, in plastic using an injection overmolding process. In the depicted embodiment, each half 300 and 350 includes one or more cavities 302a through 302d and 352a through 352d, respectively, that is configured or otherwise patterned to create a desired exterior finish of the overmolded plastic. Similar to the example mold in FIG. 2, mold half 300 may have several registration pins 304a through 304d, which insert into corresponding registration sockets 354a through 354d. Insertion of the pins 304 into the sockets 354 ensures the cavities of each half 300 and 350 are correctly and precisely mated to form the cavity into which plastic resin will be injected.

The cavities 302 and 352 are sized to accept the raw castings created from the mold depicted in FIG. 2. Each cavity, as can be seen, further has tails 312 and tabs 314 that correspond to the similar structures 208 and 210 of FIG. 2. In some embodiments, a casting from the mold of FIG. 2 may thus be held in position within its cavity by the mold securing around the tails and tabs of the raw casting. This prevents each casting from moving during the injection overmolding process, and thereby helps ensure the thickness of the plastic overmolding is consistent to its intended thickness. While the depicted cavities 302 and 352 appear roughly similar to the cavities 202 and 252 in the depicted embodiment, it should be understood that the cavities 302 and 352 may vary in appearance, depending upon the intended external appearance of the finished overmolded casting, desired wall thicknesses at various parts, and if there are features not present in the raw casting that are intended to be part of the overmolding. For example, in the mold depicted in FIG. 3, a collar 308 extends from the body of the casting along part of the tail 312. During the injection overmolding process, this collar 308 will result in a collar of plastic being overmolded upon a short section of the tail, extending from the casting body.

During the overmolding process, plastic resin is introduced into sprue 306, and travels along runners 356, which communicate the liquefied resin to each of the cavities 302 and 352 via a gate 360 associated with each cavity (only one is labeled), which contain the raw castings. Depending upon the specific embodiment, various structures may be included in the injection mold to control delivery of the injected resin, to ensure a precise coating and correct cooling. For example, in the depicted mold, a well 358 is formed at the bottom of the main runner channel opposite the sprue 356, and each cavity 302/352 may have one or more vents 310 to allow air to escape as the resin is injected.

The number, size, and placement of vents may depend upon the type of resin used in the overmolding process and the size and configuration of the cavity 302/352. HDPE, for example, may employ a single vent 310 for, and connected to, each casting that is approximately 0.003 inch in depth (only one vent is labeled), given the size of the cavity in the depicted embodiment. Depending on the embodiment, one or more of the vents 310 may communicate with the exterior of the mold, to allow air and other gasses to escape from the mold as the plastic resin is injected. A larger cavity may necessitate more gates. The gate may be sized also based upon the viscosity of the liquefied resin, to ensure that the resin does not unnecessarily escape through the vent. Different resins will require a different wall thickness, gate size based on the size of the metal object and the viscosity of the resin, its shrink rate, how brittle it is, etc.

As with the mold in FIG. 2, the mold in FIG. 3 may be manufactured from any material suitable to the plastic resin used for the overmolding process, including any release coating or agent that may be placed within the mold. The molds in FIGS. 2 and 3 may, in some embodiments, include features exterior to the internal mold structures such as cooling channels or cavities, where the casting and/or molding process requires temperature control and/or requires a forced cooling step to aid in processing times.

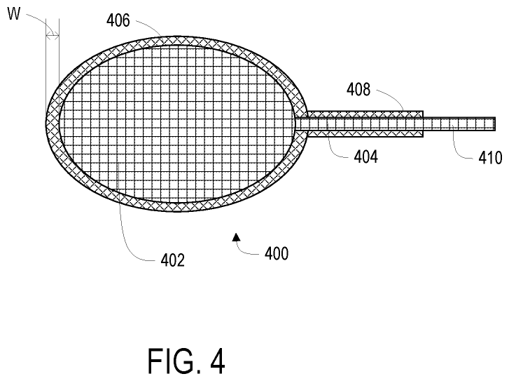

FIG. 4 illustrates in cross-section an example plastic-molded casting 400 that may result from the method 100, described above with respect to FIG. 1, and via use of the casting mold and injection mold illustrated in FIGS. 2 and 3, respectively. As can be seen, casting 400 includes a body 402 with a tail 404 that may be formed as a raw casting via a mold such as the one depicted in FIG. 2. The body 402 is covered with an injection-molded plastic cover 406. A portion of the plastic cover 406 may form a collar 408 over part of tail 404, with a remainder 410 of tail 404 left uncovered. The plastic cover 406 may have a width W, which will depend on the size of the casting 400 and the type of resin used for the coating, as described above. For example, width W may be where casting 400 is made from bismuth.

As discussed above, although disclosed embodiments are discussed with respect to creating plastic-molded bismuth castings in the form of fishing tackle, other implementations may use different metals, e.g. lead, aluminum, iron, or another metal or alloy suitable to an intended use, e.g. shot, boat anchors, crab pots, beads, spinners, bobbins, weights for throw nets, etc.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
melting a quantity of bismuth;
pouring the melted bismuth into a first mold;
placing the molded bismuth into a second mold, the second mold sized to create a space between an exterior surface of the molded bismuth and an interior surface of the second mold; and
injecting a polyethylene polymer at a predetermined temperature into the second mold until the molded bismuth is coated with the polymer.

2. The method of claim 1, wherein the polyethylene polymer is a high-density polyethylene.

3. The method of claim 1, wherein the predetermined temperature is between 45 to degrees Celsius.

4. The method of claim 3, wherein the predetermined temperature is 49 degrees Celsius.

5. The method of claim 1, wherein the second mold is sized to create the space between 0.8 and 1.0 mm in width.

6. The method of claim 5, wherein the space is 0.92 mm.

7. A casting, comprising:
a core casting comprised of metal;
an outer polymer layer that at least partially encloses the core casting, the polymer layer comprised of an injection-moldable resin.

8. The casting of claim 7, wherein the metal of the core casting comprises bismuth.

9. The casting of claim 7, wherein the outer polymer layer is between 0.8 and 1.0 mm in thickness.

10. The casting of claim 9, wherein the outer polymer layer is 0.92 mm in thickness.

11. The casting of claim 7, wherein the outer polymer layer is comprised of polyethylene.

12. The casting of claim 11, wherein the outer polymer layer is comprised of high-density polyethylene.
